(19) United States
(12) Patent Application Publication
(10) Pub. No.: US 2006/0045735 A1
(43) Pub. Date: Mar. 2, 2006

(54) Rotor-stator device having an abradable coating film

(75) Inventors: Karl Holdik, Ulm (DE); Ansgar Zoller, Neu-Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/214,511

(22) Filed: Aug. 30, 2005

(30) Foreign Application Priority Data
Aug. 30, 2004 (DE) DE102004 042127.7

(51) Int. Cl. F03B 11/02

(52) U.S. Cl. 415/208.1

(57) ABSTRACT

A device includes a rotor and a stator enclosing the rotor. The stator includes a deep-drawn workpiece and having a thermally sprayed abradable coating film deposited on the deep-drawn workpiece. A minimal gap is disposed between the rotor and the stator. In addition, a method for manufacturing the device includes the steps of forming a workpiece by deep-drawing into one of the stator and an insert of the stator, depositing an abradable coating film on the stator using a thermal spray coating method, and ablating the abradable coating film using the rotor so as to form the minimal gap.

Priority is claimed to German Patent application DE 10 2004 042 127.7, filed Aug. 30, 2004, the entire disclosure of which is hereby incorporated by reference herein.

The present invention is directed to a rotor-stator device having a coating film as well as to a method for manufacturing the same and to a suitable use thereof.

### BACKGROUND

A device and a method of this kind are already known from the German Patent DE 44 32 998 C1, which is incorporated by reference herein.

Such rotor-stator devices have been used for quite some time in compressor and turbine construction, particularly for exhaust-gas turbochargers. In known methods heretofore, the stator frames are cast, machined in secondary operations, and then provided with an abradable coating film, which is ablated until a minimal gap is formed in the direction of the rotor.

A manufacturing of this kind is relatively complex and, thus, cost intensive.

### SUMMARY OF THE INVENTION

An object of the present invention is, therefore, to devise an equivalent rotor-stator device which will be able to be manufactured less expensively.

The present invention provides a device that includes a rotor and a stator enclosing the same, the stator having an abradable coating film and a minimal gap in the direction of the rotor, wherein the stator is made at least partially of a deep-drawn workpiece, and the abradable coating film is deposited on the workpiece using a thermal spray coating method. The present invention also provides a method for manufacturing a device having a rotor and a stator enclosing the same, the stator having an abradable coating film and exhibiting a minimal gap in the direction of the rotor, wherein a workpiece is formed into the stator or a stator insert by deep-drawing; an abradable coating film is deposited on the stator using a thermal spray coating method; the abradable coating film is ablated by the rotor until a minimal gap is formed.

The present invention provides a rotor-stator device in which in the stator is made at least partially of a workpiece that is formed by deep-drawing, and in that the abradable coating film is deposited on the workpiece using a thermal spray coating method.

Forming methods, in particular deep-drawing, are significantly less expensive than machining methods. A lower workpiece accuracy may easily be compensated by the abradable coating film, which, in operation, is ablated to a precise minimal gap dimension.

It is advantageous to both manufacture the entire stator using a deep-drawing process, as well as merely an insert that may be introduced, preferably pressed into a conventionally cast rear construction. The need is still eliminated in the latter case for the cost intensive machine-cutting step.

The stator or a stator insert may be manufactured very simply and cost-effectively by the deep drawing of sheet-metal panels, preferably of sheet-steel panels. Also conceivable, however, is the use of other planar materials, such as fiber-reinforced, curable plastics, in particular CFRP (carbon fiber-reinforced plastic) mats.

Thermal deformation of a sheet-metal stator may be minimized by annealing processes.

The adhesion of the abradable coating film to the stator may be improved by roughening the same before applying the film.

The greater amount of noise generated by a sheet-metal stator in comparison to a cast stator may be minimized by the thickness of the abradable coating film, which provides acoustical absorption.

The abradable coating film may be deposited very simply, quickly, and cost-effectively on the workpiece using a thermal spray coating method.

The present invention further provides a method wherein a workpiece is formed into the stator or a stator insert by deep-drawing, in that an abradable coating film is deposited on the stator or stator insert using a thermal spray coating method, and in that the abradable coating film is ablated by the rotor until a minimal gap is formed.

It is particularly advantageous to use a pre-cut sheet-metal panel as a workpiece, to deep-draw this workpiece in accordance with the required stator geometry, and/or to anneal the stator and/or to roughen the stator. The advantages derived thereform have already been described above with respect to the device.

A rotor-stator device of this kind is used very advantageously in an exhaust-gas turbocharger. When working with such a mass-produced product, even comparatively modest cost advantages lead to substantial overall savings in the production.

### BRIEF DESCRIPTION OF THE DRAWING

The present invention is described in more detail below with respect to the drawing, in which:

FIG. 1 shows a schematic view of a portion of a rotor-stator device according to the present invention.

### DETAILED DESCRIPTION

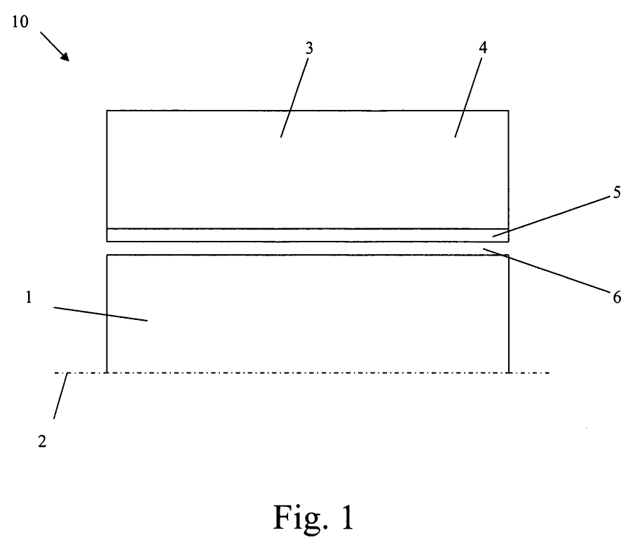

FIG. 1 a schematic view, of a portion of rotor-stator device 10 is shown schematically. Rotor 1, which rotates around axis 2 and is enclosed by stator 3. Stator 3 is made, at least partially, from a deep drawn workpiece 4. An abradable coating 5 is disposed on the workpiece 4 using a thermal spray coating method. A minimal gap 6 is disposed between the stator 3 and the rotor 1. The components shown in FIG. 1 are not drawn to scale.

The method according to the present invention and the device according to the present invention are explained in greater detail in the following, on the basis of two exemplary embodiments:

In accordance with a first exemplary embodiment, a rotor-stator device for the compressor side of an exhaust-gas turbocharger is manufactured. To this end, a frame having rough geometry is cast from aluminum alloy, and a deep-drawn AlMgSi_{0.5} sheet-metal insert is pressed into this unfinished stator. Using thermal spray-coating processes (for example, atmospheric plasma spraying), an abradable coating film of AlSi₁₂ and polyester is applied up to a thickness of approximately 200 μm, and ablated during assembly or in operation by the rotor to a minimal coating thickness of approximately 50 μm.

In accordance with a second exemplary embodiment, a rotor-stator device for the turbine side of the exhaust-gas turbocharger of a diesel engine is manufactured. To this end, the stator is initially deep-drawn from sheet metal and subsequently annealed at a temperature of approximately 650° C. for a period of 90 minutes. The surface facing the rotor is roughened by a high-pressure water jet, and, using thermal spray-coating processes (for example, atmospheric plasma spraying), an abradable coating film of NiCrAlY and polyester is subsequently applied up to a thickness of approximately 300 μm, and ablated during assembly or in operation by the rotor to a minimal coating thickness of approximately 100 μm. The minimal gap dimension automatically adjusts itself as a function of the plain bearing of the rotor used.

Plain bearings feature a rotor which rotates within a housing coated on the inside with a bearing film. Disposed between the bearing film and the rotor is a gap, the so-called bearing clearance, which is typically supplied with fluid, for the most part oil. Depending on the intended application of the plain bearing, the gap width varies between 50 and 500 μm, mostly between 100 and 300 μm. If the fluid pressure is reduced, the rotor and its axis of rotation are thereby displaced in parallel to the axis of symmetry of the housing, in response to the action of the centripetal force. In this context, the extent of the displacement increases with the reduction in the lubricant pressure.

For the rotor-stator device according to the present invention, it is merely necessary that the rotor be secured axisymmetrically to the stator, and that the modified plain bearing be positioned axisymmetrically with respect to the stator. The rotor is then set into rotation and ablates a portion of the abradable coating film. The rotor may subsequently be centered again relative to the stator in response to the lubricant pressure acting again on the plain bearing.

In the embodiments of the examples described above, the device and the method according to the present invention prove to be especially suited for the exhaust-gas turbocharger, in the automotive industry, in particular.

Significant advantages are able to be derived with respect to the manufacturing time and the costs entailed.

The present invention is not limited to the specific embodiments as illustrated above, but rather should be understood to encompass other aspects as well.

Thus, it is conceivable, for example, to manufacture high-density pumps having rotor-stator devices of this kind.

What is claimed is:

1. A device comprising:
a rotor;
a stator enclosing the rotor, the stator including a deep-drawn workpiece and a thermally sprayed abradable coating film deposited on the deep-drawn workpiece; and
a minimal gap disposed between the rotor and the stator.

2. The device as recited in claim 1, wherein the stator includes sheet metal.

3. The device as recited in claim 2, wherein the stator includes deep-drawn sheet metal.

4. The device as recited in claim 2, wherein the stator includes annealed sheet metal.

5. The device as recited in clam 2, wherein the stator includes roughened sheet metal.

6. The device as recited in claim 1, wherein the device is one of a compressor and a turbine.

7. The device as recited in claim 1, wherein the device forms at least part of an exhaust-gas turbocharger.

8. A method for manufacturing a device having a rotor, a stator enclosing the rotor and having an abradable coating film, and a minimal gap between the rotor and the stator, the method comprising:
forming a workpiece by deep-drawing into one of the stator and an insert of the stator;
depositing an abradable coating film on the stator using a thermal spray coating method; and
ablating the abradable coating film using the rotor so as to form the minimal gap.

9. The method as recited in claim 7, wherein the workpiece is deep-drawn.

10. The method as recited in claim 7, further comprising annealing the stator.

11. The method as recited in claim 7, wherein the stator is roughened.
